(19) United States
(12) Patent Application Publication
(10) Pub. No.: US 2013/0077634 A1
(43) Pub. Date: Mar. 28, 2013

(54) Systems and Methods of Providing Outside Plant Transport Gateway

(71) Applicant: Jeff Finkelstein, Alpharetta, GA (US)

(72) Inventor: Jeff Finkelstein, Alpharetta, GA (US)

(73) Assignee: COX COMMUNICATIONS, INC., Atlanta, GA (US)

(21) Appl. No.: 13/241,055

(22) Filed: Sep. 22, 2011

(51) Int. Cl. H04L 12/56

(52) U.S. Cl. 370/401

(57) ABSTRACT

In example embodiments of systems and methods of outside plant transport gateway provided herein, instead of locating the gateway/media converter inside the customer premises, the gateway/media converter is located outside the customer premises and may be configured to provide access/media conversion for multiple homes. In previous systems, the gateway/media converter is located in the customer premises. However, the customer premises must be entered to perform maintenance or other work. Moving the gateway/router outside of the customer premises offers easier maintenance at the gateway level.

### TECHNICAL FIELD

The present disclosure is generally related to telecommunications and, more particularly, is related to telecommunications gateways/routers.

### BACKGROUND

In telecommunications, a gateway and an associated media converter (which may be integrated) may refer to a network node equipped for interfacing with another network that uses different protocols. A gateway may contain devices such as protocol translators, impedance matching devices, rate converters, fault isolators, or signal translators as necessary to provide system interoperability. It also requires the establishment of mutually acceptable administrative procedures between both networks.

A protocol translation/mapping gateway interconnects networks with different network protocol technologies by performing the required protocol conversions. Gateways, also called protocol converters, can operate at any network layer. The activities of a gateway are more complex than that of the router or switch as it communicates using more than one protocol. There are heretofore unaddressed needs with previous solutions.

### SUMMARY

Example embodiments of the present disclosure provide systems of outside plant transport gateway. Briefly described, in architecture, one example embodiment of the system, among others, can be implemented as follows: a media converter located outside of customer premises, the media converter configured to receive packets from an access network in a first format, to convert the packets from the first format to a second format; and to transmit packets the packets in a second format to one or more customer premises equipment units (CPEUs).

Embodiments of the present disclosure can also be viewed as providing methods for outside plant transport gateway. In this regard, one embodiment of such a method, among others, can be broadly summarized by the following steps: receiving packets in a media converter located outside customer premises, the packets received from an access network in a first medium; converting the packets from the first medium to a second medium; and transmitting the packets to customer premises equipment units (CPEUs).

### BRIEF DESCRIPTION OF THE DRAWINGS

FIG. 1 is a system diagram of a customer premises telecommunications routing system.

FIG. 2 is a system diagram of an example embodiment of an outside plant transport gateway.

FIG. 3 is a system diagram of service provider network for providing telecommunications services to a customer premises.

FIG. 4 is a system diagram of an example embodiment of a service provider network using the outside plant transport gateway of FIG. 2.

FIG. 5 is a system diagram of an example embodiment of a physical plant used in the service provider network of FIG. 4.

FIG. 6 is a flow diagram of an example embodiment of a method of providing an outside plant transport gateway.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

A gateway is a network point that acts as an entrance to another network. On the Internet, both the computers of Internet users and the computers that serve pages to users are host nodes, while the nodes that connect the networks in between are gateways. For example, the computers that control traffic between company networks or the computers used by internet service providers (ISPs) to connect users to the internet are gateway nodes.

In the network for an enterprise, a computer server acting as a gateway node is often also acting as a proxy server and a firewall server. A gateway is often associated with both a router, which knows where to direct a given packet of data that arrives at the gateway, and a switch, which furnishes the actual path in and out of the gateway for a given packet.

On an IP network, clients should automatically send IP packets with a destination outside a given subnet mask to a network gateway. A subnet mask defines the IP range of a private network. For example, if a private network has a base IP address of 192.168.0.0 and has a subnet mask of 255.255.255.0, then any data going to an IP address outside of 192.168.0.X will be sent to that network's gateway. While forwarding an IP packet to another network, the gateway might or might not perform Network Address Translation.

A gateway is an essential feature of most routers, although other devices (such as any PC or server) can function as a gateway. Most computer operating systems use the terms described above. A computer running Microsoft Windows however describes this standard networking feature as Internet Connection Sharing, which will act as a gateway, offering a connection between the Internet and an internal network. Such a system might also act as a DHCP server. Dynamic Host Configuration Protocol (DHCP) is a protocol used by networked devices (clients) to obtain various parameters necessary for the clients to operate in an Internet Protocol (IP) network. By using this protocol, system administration workload greatly decreases, and devices can be added to the network with minimal or no manual configurations.

A residential gateway is a home networking device, used as a gateway to connect devices in the home to the Internet or other WAN. It is an umbrella term, used to cover multi-function networking computer appliances used in homes, which may combine a DSL modem or cable modem, a network switch, providing LAN switching, a consumer-grade router, and a wireless access point. In the past, such functions were provided by separate devices, but by technological convergence, they have often merged into a single device.

Multiple devices have been described as “residential gateways,” each with a different function. Each type of device allows the connection of a LAN (used in the home) to a WAN. The WAN can often be the Internet or can merely be a larger LAN of which the home is a part (such as a municipal WAN that provides connectivity to the residences within the municipality). WAN connectivity may be provided through DSL, cable modem, a broadband mobile phone network, or other connections.

The term “residential gateway” was originally used to distinguish the inexpensive networking devices designated for use in the home from similar devices used in corporate LAN environments (which generally offered a greater array of capabilities). In recent years, however, the less expensive “residential gateways” have gained many of the capabilities of corporate gateways and the distinctions are fewer. Many home LANs now are able to provide most of the functions of small corporate LANs. Therefore the term “residential gateway” sometimes implies a less expensive, lower capability networking device.

The home gateway tends to have abundant interfaces, powerful functions and a more user-friendly interface. It is a manageable terminal with auto-configuration, and multi-service perceiving and bearing. The home gateway provides Quality of Service functionality to simultaneously support different types of services. As a part of the carrier network, the home gateway may support remote control, detection and configuration.

Since the early 2000s the residential or home gateway has been used by Telecommunications Multiple Service Operators [MSOs] as a termination device for connecting consumer premises to a broadband delivery network, each home containing at least one gateway. Media converter functionality in the gateway plays an important role in today's multiprotocol, mixed-media local area networks (LANs). For example, LAN administrators can deploy media converters to integrate fiber optic cabling and active equipment into existing copper-based, structured cabling systems while achieving significant cost savings. Media converters are also becoming a critical piece of data networks outside the LAN, as electrical-to-optical conversion technology is enabling service providers to speed up the deployment of and minimize the cost of provisioning fiber-to-the-subscriber, and offering MAN access and data transport services to enterprise customers. Media converters are simple networking devices that make it possible to connect two dissimilar media types, such as twisted pair with fiber optic cabling. Today's converters support many different data communication protocols—including Ethernet, Fast Ethernet, Gigabit Ethernet, T1/E1/J1, DS3/E3—as well as multiple cabling types such as coax, twisted pair, multimode and single-mode fiber optics.

Media converter types range from small standalone devices and PC card converters to high-port-density chassis systems that offer many advanced features for network management. Simple network management protocol (SNMP) enables proactive management of link status, monitoring chassis environmental statistics, and sending traps to network managers in the event of a fiber break or even link loss on the copper port. The ability to quickly identify and isolate problems allows LAN administrators to maximize network uptime.

In distributed networking, such as providing network service to a customer premises, the gateway may be located inside the home, a non-limiting example of which is a Data Over Cable Service Interface Specification (DOCSIS) cable modem. In an example embodiment of the disclosed systems and methods of providing outside plant transport gateway, the gateway/media converter may be placed outside of the customer premises instead of inside the customer premises. The gateway may be moved out to the physical plant of the service provider and filters may be used to provide services to several customer premises from a single gateway.

The disclosed systems and methods of providing outside plant transport gateway may include embedded DOCSIS cable modems with coax cables running from the gateway to the inside of the premises. In an example embodiment, the gateway may have phone line access, a battery, and/or a router, among other functions. The gateway may convert to and from Multimedia over Coax Alliance (MoCA) standard communication, WiFi communication, among other communication capabilities.

In an example embodiment, instead of locating the gateway/media converter inside the customer premises, the gateway/media converter is located outside the customer premises and may be configured to provide access/media conversion for multiple homes. In previous systems, the gateway/media converter is located in the customer premises. However, the customer premises must be entered to perform maintenance or other work. Moving the gateway/router outside of the customer premises offers easier maintenance at the gateway level. Additionally, services may be suspended remotely. Multiple customers (for example, 4, 8, 10, 16, etc.) may be serviced from a single outside gateway/media converter. The device cost for one home may now be spread across multiple homes.

In an example embodiment, the transmission topology may be one or more topologies such as non-limiting examples of MoCA, Ethernet, coax, and WiFi. Entry into the home may be accomplished through different types of routers, including IEEE 802.11 and fiber optics, among others. In an example embodiment, only a receiver is used in the home. Example embodiments of the disclosed systems and methods receive power from feeder legs of the service provider physical plant, instead of using household power.

In an example embodiment, the disclosed systems and methods use MoCA technology to feed multiple homes. An example implementation may use a cable modem or an optical multiplexer unit (OMU) chip, and the feeder may implement MoCA or Ethernet passive optical network (EPON). In an example embodiment, the disclosed systems and methods have no a priori knowledge of any account information. The disclosed systems and methods receive communications from the access network, convert the communications to another format, such as MoCA as a non-limiting example, and send them out. The router functionality builds a set of MAC tables based on the devices in the homes that it is communicating with. Communications intended for customer #2 will not be sent to customer #1 because the router knows which customer is present on a particular pipe, such as a physical fiber for example. In an example embodiment, there is no account information; the gateway/router simply receives that communications from the access network.

In an example embodiment, permissions are handled in the access network in the server provider head end. There may a second media converter that exists in the head end, which, in the DOCSIS topology, is called a cable modem termination system (CMTS). In the fiber topology, it is called an optical line terminal (OLT), and in the wireless topology, it is called a base station. In an example embodiment, the gateway/router comprises a MAC layer and MAC bridging technology, which receives incoming packets. The gateway/router sends out only those packets destined for the customers that are on a specific communications path.

In an example embodiment, the embedded cable modem, or ECM, has voice capabilities. With the gateway/router situated outside the customer premises, the communication packets are converted outside of the customer premises. Point of Entery (POE) filters prohibit users from receiving communications not intended for them. The POE also blocks any returning signal that is not destined for the router.

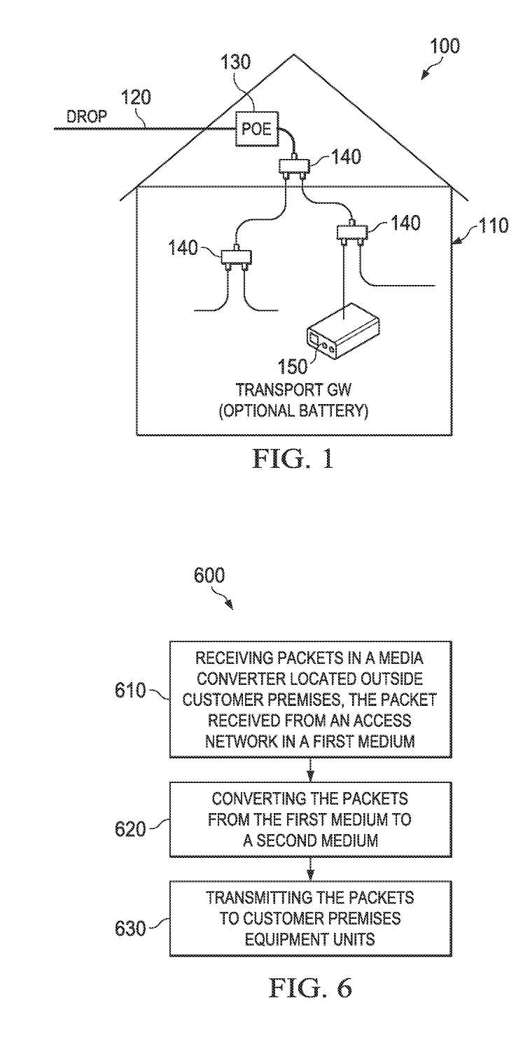

FIG. 1 provides system block diagram 100 of a prior art gateway/router system into customer premises 110. The service provider provides a communications service on drop 120, which is filtered with POE filter 130. The provided service may then be split one or more times with splitter(s) 140 where it is presented to transport gateway 150. Gateway 150 comprises a media converter to convert the transport medium of the service provider into the medium required by the customer premises equipment.

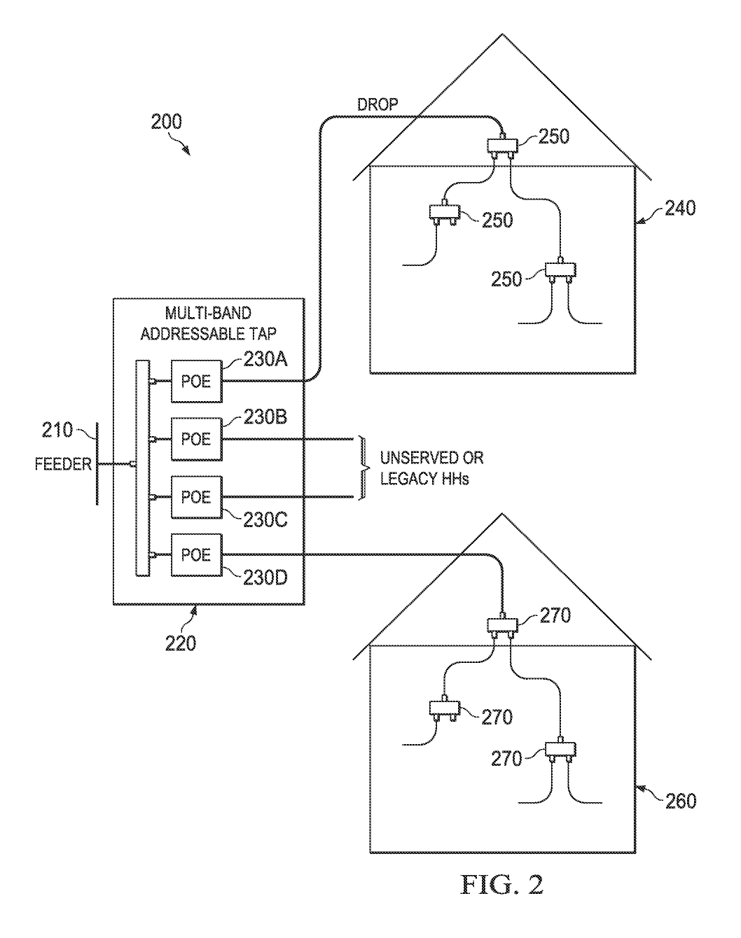

FIG. 2 provides system block diagram 200 of an example embodiment of a system of providing outside plant transport gateway. System 200 comprises feeder 210; media converter 220 which may include one or more of multi-band addressable taps and a corresponding POE filters 230A, 230B, 230C, and 230D; first customer premises 240 with one or more splitters 250; and second customer premises 260 with one or more splitters 270. The splitters are optional and may not be present in one or more of customer premises 240, 260. The media conversion occurs in media converter 220. The telecommunications service is provided on feeder 210 in a first media type, converted to a second media type by media converter 220 and then sent to customer premises 240, 250 by one or more transmission means.

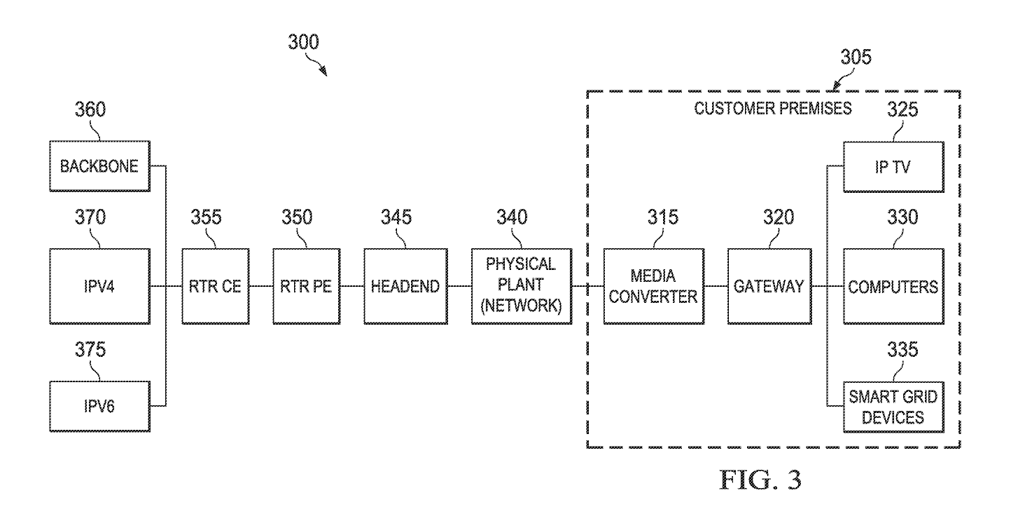

FIG. 3 provides system diagram of service system 300 as previously used in the industry. Equipment in customer premises 305 may include IP-enabled TVs 325, computers 330, and smart-grid devices 335 such as refrigerators, washers, dryers, lights, and other devices that have power monitoring capability, among others—any devices that may need to communicate. Gateway device 320 is inside customer premises 305 and connects one or more of the communicating customer premises devices to media converter 315, which is also located inside customer premises 305. Gateway device 320 may communicate to the customer premises devices by Ethernet, wireless IEEE 802.11, and MoCA, among others. Communication topologies used by media converter 315 include non-limiting examples of DOCSIS, passive optical network (PON), and wireless, such as a 3G or 4G wireless connection, among others. Media converter 315 is in communication with physical plant network 340 of the service provider, which could be, as non-limiting examples, fiber, HFC, and wireless, among others. Physical plant 340 is in communication with headend 345, which is in communication with provider edge router 350, which in turn communicates with core edge router 355. Core edge router 355 may connect to at least one of backbone 360, IPV4 internet 370, and IPV6 internet 375.

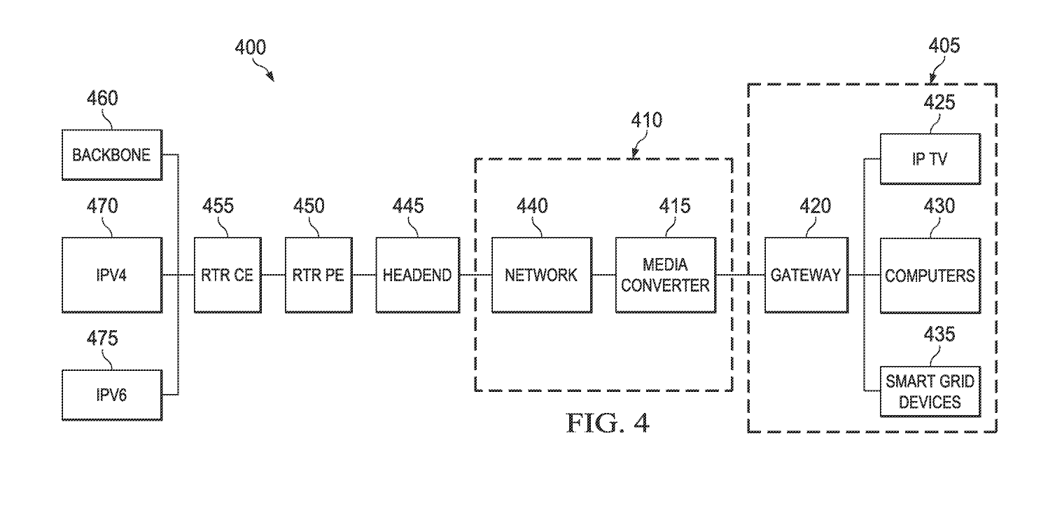

FIG. 4 provides system 400 for providing outside plant transport gateway. Since physical plant 410 is powered, media converter 415 is moved out into physical plant 410, and still provide the conversion. In an example embodiment, gateway 420 remains in the customer premises. However, the gateway functionality may be located in physical plant 410 as well. The power to run the media converter is fairly small, which makes it feasible to locate it in physical plant 410. In an example embodiment, the tap is replaced with the transplant gateway 420. Some of the complexity in the customer premises 405, for example, all the POE filters, may be relocated to physical plant 410. Communication topologies used by media converter 415 include non-limiting examples of DOCSIS, passive optical network (PON), and wireless, such as a 3G or 4G wireless connection, among others. Media converter 415 is in communication with physical plant network 440 of the service provider, which could be, as non-limiting examples, fiber, HFC, and wireless, among others. Physical plant network 440 is in communication with headend 445, which is in communication with provider edge router 450, which in turn communicates with core edge router 455. Core edge router 455 may connect to at least one of backbone 460, IPV4 internet 470, and IPV6 internet 475.

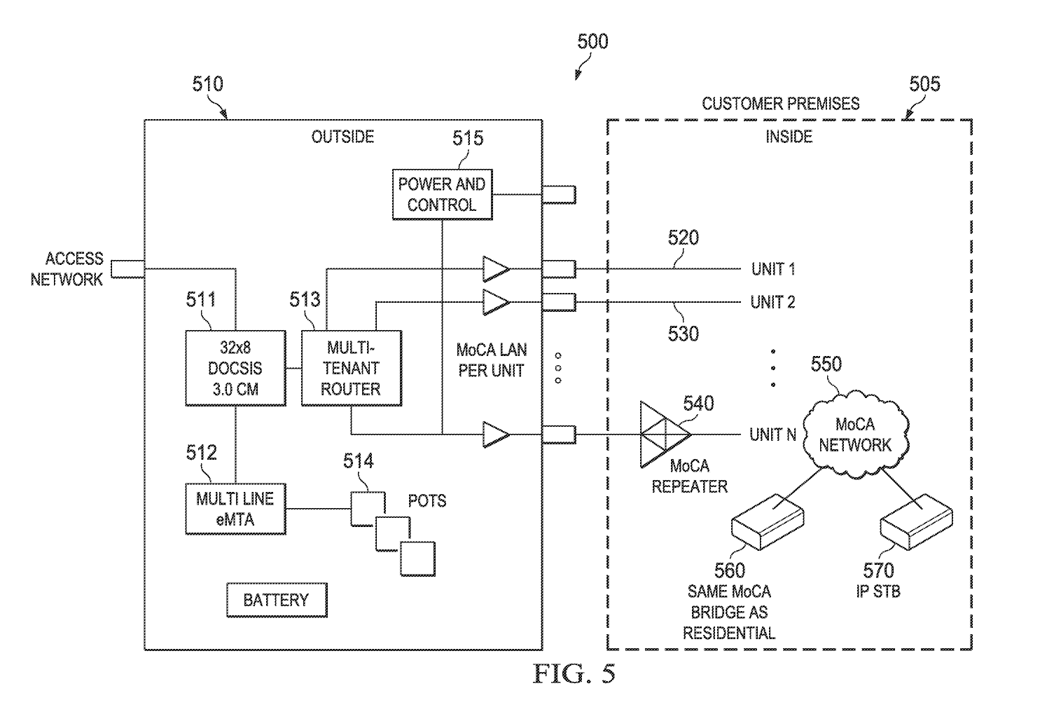

FIG. 5 provides system block diagram 500 of an example embodiment of physical plant 510 interfacing with customer premises 505. This example embodiment of physical plant 510 includes power and control module 515, multi tenant router 513, DOCSIS cable modem 511, multi-line embedded multimedia terminal adapter 512 which may provide voice over internet protocol (VoIP) service to a plain old telephone system (POTS). DOCSIS cable modem 511 converts packets between the medium of the access network to the medium of multi-tenant router 513. In an example embodiment, multi-tenant router 513 routes signals from DOCSIS cable modem 511 to one or more customer premises equipment units 520, 530, as well as MoCA repeater 540. MoCA repeater 540 may interface with MoCA network 550, which may interface with one or more MoCA devices, such as non-limiting examples of MoCA bridge 560 and IP set top box (STB) 570.

FIG. 6 provides a flow diagram of method 600 of providing outside plant transport gateway. In block 610, packets in a first medium are received from an access network. The packets are received by a media converter located outside of customer premises. In block 620, the media converter converts the packets from the first medium to a second medium. In block 630, the packets in the second medium are transmitted to customer premises equipment units.

The flow chart of FIG. 6 shows the architecture, functionality, and operation of a possible implementation of outside plant transport gateway software. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 6 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A system comprising:
a media converter located outside of customer premises, the media converter configured to receive packets from an access network in a first format, to convert the packets from the first format to a second format; and to transmit packets the packets in a second format to one or more customer premises equipment units (CPEUs).

2. The system of claim 1, wherein the media converter is powered by a service provider physical plant.

3. The system of claim 1, wherein the media converter is configured to transmit packets to a plurality of types of CPEUs.

4. The system of claim 3, wherein the CPEUs comprise at least one of an internet protocol television, a personal computer, and a smart grid device.

5. The system of claim 1, wherein the media converter transmits packets to at least one of a multimedia over coax alliance (MoCA) network, an Ethernet network, and an IEEE 802.11 network.

6. The system of claim 1, wherein the media converter transmits packets to at least one of a multimedia over coax alliance (MoCA) device, an Ethernet device, and an IEEE 802.11 device.

7. The system of claim 1, wherein the media converter receives packets from at least one of a fiber-based access network, a wireless access network, and a hybrid-fiber-coaxial (HFC) access network.

8. The system of claim 1, wherein the media converter is further configured to receive packets from the CPEUs and to transmit packets to the access network.

9. The system of claim 1, wherein the media converter is further configured to convert the received packets from a format of the access network to a format of at least one of the CPEUs.

10. A method comprising:
receiving packets in a media converter located outside customer premises, the packets received from an access network in a first medium;
converting the packets from the first medium to a second medium; and
transmitting the packets to customer premises equipment units (CPEUs).

11. The method of claim 10, further comprising powering the media converter by a service provider physical plant.

12. The method of claim 10, wherein transmitting packets to CPEUs further comprises transmitting packets to a plurality of types of CPEUs.

13. The method of claim 12, wherein the CPEUs comprise at least one of an internet protocol television, a personal computer, and a smart grid device.

14. The method of claim 10, wherein transmitting packets further comprises transmitting packets to at least one of a multimedia over coax alliance (MoCA) network, an Ethernet network, and an IEEE 802.11 network.

15. The method of claim 10, wherein transmitting packets further comprises transmitting packets to at least one of a multimedia over coax alliance (MoCA) device, an Ethernet device, and an IEEE 802.11 device.

16. The method of claim 10, wherein receiving packets further comprises receiving packets from at least one of a fiber-based access network, a wireless access network, and a hybrid-fiber-coaxial (HFC) access network.

17. The method of claim 10, wherein receiving packets further comprises receiving packets from the CPEUs and transmitting packets further comprises transmitting packets to the access network.

18. The method of claim 10, further comprising converting the received packets from a format of the access network to a format of at least one of the CPEUs.

19. A service provider physical plant comprising:
a power supply;
a router powered by the power supply; and
a media converter powered by the power supply, the media converter configured to
transceive packets with an access network in a first format;
convert the packets to and from a second format, the second format defined by a customer premises equipment unit; and
transceive packets in the second format with the CPEU through the router.

20. The system of claim 15, wherein the media converter is further configured to receive packets from at least one of a fiber-based access network, a wireless access network, and a hybrid-fiber-coaxial (HFC) access network and to transmit packets to at least one of a multimedia over coax alliance (MoCA) network, an Ethernet network, and an IEEE 802.11 network.
